(19) United States
(12) Patent Application Publication
(10) Pub. No.: US 2013/0156257 A1
(43) Pub. Date: Jun. 20, 2013

(54) IMAGE PROCESSING DEVICE, TAMPERING PREVENTION METHOD, AND TAMPERING DETECTION METHOD

(71) Applicant: Fujitsu Limited, Kawasaki-shi (JP)

(72) Inventors: Taizo ANAN, Kawasaki (JP); Kohji Yamada, Kawasaki (JP)

(73) Assignee: Fujitsu Limited, Kawasaki-shi (JP)

(21) Appl. No.: 13/659,986

(22) Filed: Oct. 25, 2012

(30) Foreign Application Priority Data
Dec. 15, 2011 (JP) 2011-275061

(51) Int. Cl. G06K 9/00

(52) U.S. Cl. 382/100

(57) ABSTRACT

An image processing device includes a frequency calculation part configured to calculate frequency coefficients of an image, a coefficient selection part configured to select plural pairs of the frequency coefficients from the calculated frequency coefficients, a code generation part configured to generate a code based on a comparison result between an absolute value of a difference between the two frequency coefficients of each of the selected pairs and a threshold, and a magnitude relationship between the two frequency coefficients, and a signature generation part configured to encrypt the generated code with a private key to generate a digital signature.

This patent application is based upon, and claims the benefit of priority of Japanese Patent Application No. 2011-275061 filed on Dec. 15, 2011, the entire contents of which are incorporated herein by reference.

### FIELD

The embodiments discussed herein relate to an image processing device, a tampering prevention method, and a tampering detection method.

### BACKGROUND

Recent developments in the digital technology and the arrival of digital cameras capable of capturing digital images have dramatically facilitated the editing of static images and dynamic images (hereinafter these two types of images are also simply called an “image” or “images”). However, tampering with the captured image has become more problematic as the editing of the images becomes easier.

According to television (TV) news, it is mandatory to submit scene photographs of the construction that has been ordered by the central and local governments in order to verify whether the construction work has been carried out appropriately. The central government has scrutinized a little over 200,000 scene photographs in the investigation of approximately 100 public work cases, and found that a little over 1,000 photographs are strongly suspected of being tampered with.

Tampering with an image is typically carried out by image editing software. For example, the color of the traffic signal in a road accident photograph may be easily altered in order to turn a situation to one's advantage.

As examples of the tampering prevention technology for preventing such digital image tampering, a digital signature or digital watermark may be given. Further, the digital watermark includes a fragile watermark, and a semi-fragile watermark.

FIG. 1 is a diagram illustrating properties of different tampering prevention technologies. As illustrated in FIG. 1, the different tampering prevention technologies have the following properties.

Digital signature: Recompression is detected as tampering. High resistance to hacking.

Fragile watermark: Recompression is detected as tampering. Medium resistance to hacking.

Semi-fragile watermark: Recompression is not detected as tampering. Low resistance to hacking.

The recompression indicates recompressing of the compressed image. The recompression may be carried out for reducing the required capacity of storage. The hacking indicates tampering with an image or the like without being noticed.

The most frequently used one of the above tampering prevention technologies may be the digital signature. The digital signature technology does not permit tampering with any bit of pixels of the image, and hence, provides high resistance to hacking.

The fragile watermarking technology utilizes digital watermarking technology. In the fragile watermarking technology, a watermark that is extremely fragile and easily broken by editing is embedded in a signal, and tampering is detected by scrutinizing whether the fragile watermark has been broken. The fragile watermarking technology does not permit tampering with any bit of pixels of the image, and hence, detects the image recompression as tampering. The fragile watermarking technology provides medium resistance to hacking.

The semi-fragile watermarking technology detects only major tampering, and does not detect minor tampering. The semi-fragile watermarking technology is developed for handling the image recompression.

FIG. 2 is a diagram illustrating a problem associated with the recompression. In the example of FIG. 2, the compression ratio of an image subjected to tampering detection is set at low when the image is taken in order to maintain the quality of the image. However, a user frequently desires to store the aforementioned image on a disk by recompressing the image in order to use the minimum capacity of the storage even if the image is degraded.

However, in the digital signature and fragile watermarking technologies, even the difference of one bit is detected as tampering. Hence, even if the digital signature and the digital watermark provided in images serve a tampering detection function or a tampering prevention function, the stored recompressed images may all be detected as tampered images.

The semi-fragile watermarking technology detects apparently malicious tampering, and does not detect the image recompression as tampering. However, despite its convenience, the robustness of the semi-fragile watermarking technology is, unlike the digital signature, not mathematically verified. Further, if the watermarking algorithm embedded in an image is leaked, it may be possible for a malicious user to temporarily remove the watermark from the image, tamper with the image, and place the watermark back on the image. Thus, the semi-fragile watermarking technology may have low resistance to hacking.

It is important to provide the result of tampering detection indicating that no tampering is found in the image with high probability as evidence in a trial. Compared to the digital signature, the semi-fragile watermarking technology may only provide weak mathematical grounds to indicate the image being not tampered with, and resistance to hacking.

### RELATED ART DOCUMENT

Non-Patent Document 1: Takao Nakamura1 and Youichi Takashima, The Journal of The Institute of Image Information and Television Engineers Vol. 61 (2007) No. 7 P 948-950

### SUMMARY

According to an aspect of the embodiments, there is provided an image processing device that includes a frequency calculation part configured to calculate frequency coefficients of an image; a coefficient selection part configured to select a plurality of pairs of the frequency coefficients from the calculated frequency coefficients; a code generation part configured to generate a code based on a comparison result between an absolute value of a difference between the two frequency coefficients of each of the selected pairs and a threshold, and a magnitude relationship between the two frequency coefficients; and a signature generation part configured to encrypt the generated code with a private key to generate a digital signature.

The object and advantages of the invention will be realized and attained by means of the elements and combinations particularly pointed out in the appended claims.

It is to be understood that both the foregoing general description and the following detailed description are exemplary and explanatory and are not restrictive of the invention.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a diagram illustrating the properties of different tampering prevention technologies;

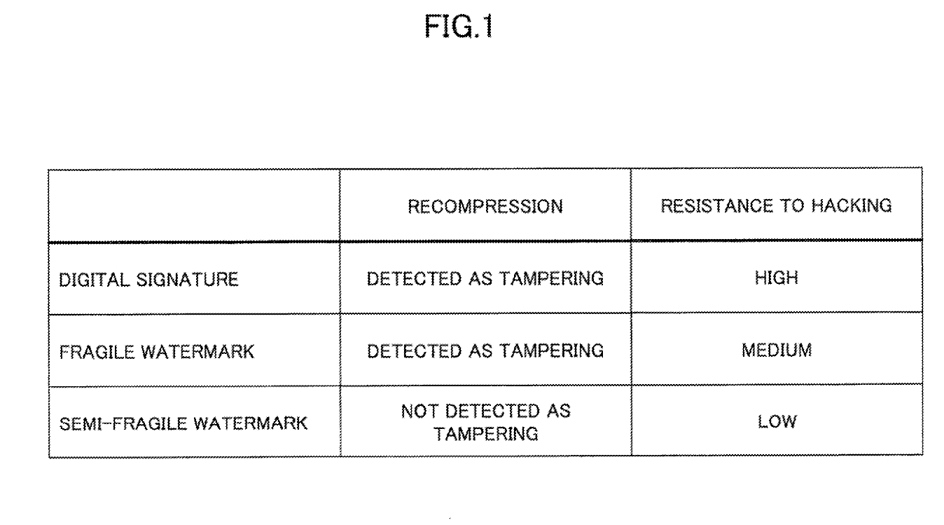

FIG. 2 is a diagram illustrating a problem of recompression;

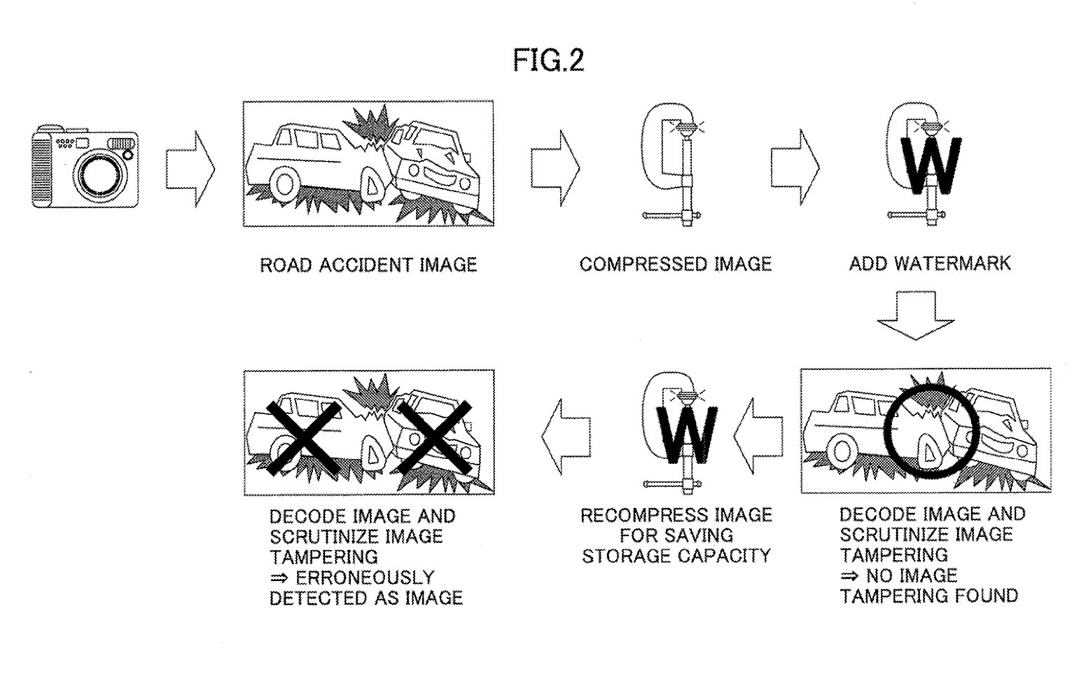

FIG. 3 is a diagram illustrating an example of a system that prevents and detects tampering;

FIG. 4 is a diagram illustrating an example of a configuration of an image processing device;

FIG. 5 is a block diagram illustrating an example of a tampering prevention function in a first embodiment;

FIG. 6 is a diagram illustrating a method for selecting a combination of two frequency coefficients;

FIG. 7 is a diagram illustrating another method for selecting a combination of two frequency coefficients;

FIG. 8 is a diagram illustrating a specific example of generating a code D;

FIG. 9 is a flowchart illustrating an example of tampering prevention processing in the first embodiment;

FIG. 10 is a block diagram illustrating an example of a tampering prevention function in a second embodiment;

FIG. 11 is a diagram illustrating another specific example of generating a code D;

FIG. 12 is a flowchart illustrating an example of tampering prevention processing in the second embodiment;

FIG. 13 is a diagram illustrating an example of a configuration of an image processing device;

FIG. 14 is a block diagram illustrating an example of a tampering detection function in a third embodiment; and

FIG. 15 is a flowchart illustrating an example of tampering detection processing in the third embodiment.

### DESCRIPTION OF EMBODIMENTS

The technology disclosed below may provide an image processing device, a tampering prevention method, and a tampering detection method that may provide mathematical grounds indicating an image being not tampered with while not detecting a compressed image as being tampered with.

In the following, preferred embodiments will be described with reference to the accompanying drawings.

System

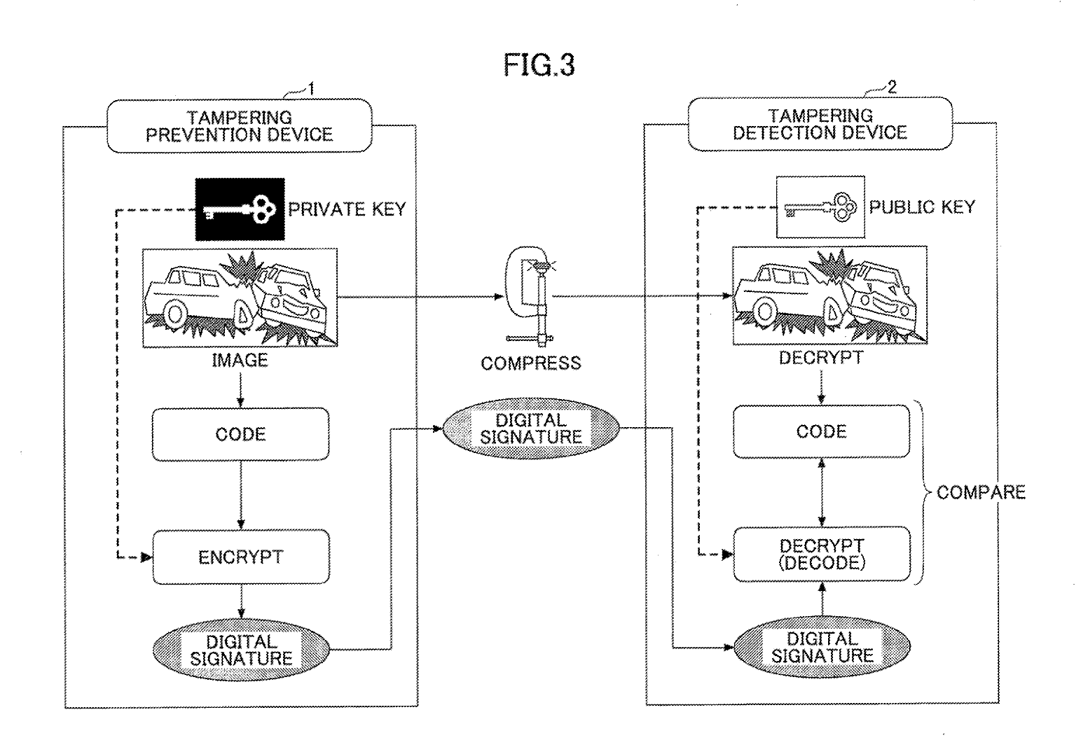

First, a tampering prevention and tampering detection system is described. FIG. 3 is a diagram illustrating an example of a system that prevents and detects tampering. FIG. 3 illustrates a relationship between a tampering prevention device 1 and a tampering detection device 2.

The tampering prevention device 1 is configured to encrypt a code generated from an image with a unique private key to create a digital signature. The tampering prevention device 1 sends a public key corresponding to the unique private key, the digital signature, and a compressed image to the tampering detection device 2.

The tampering detection device 2 generates a code from an image subjected to tampering detection. Further, the tampering detection device 2 decrypts the digital signature received from the tampering prevention device 1 with the public key corresponding to the private key to generate a code. The tampering detection device 2 compares the two codes. If the two codes match, the tampering detection device 2 determines that there is no tampering with an image, whereas if the two codes do not match, the tampering detection device 2 determines that there is tampering with an image. According to this system, when the image is compressed, the compressed image is not simply detected as tampering. Further, according to this system, the tampering detection may be carried out within the framework of the digital signature. Hence, the system may be able to carry out mathematically robust tampering detection. The tampering prevention device 1 and the tampering detection device 2 are described further in detail below.

### First Embodiment

First, an image processing device 10 according to a first embodiment that serves as the tampering prevention device 1 is described.

Configuration

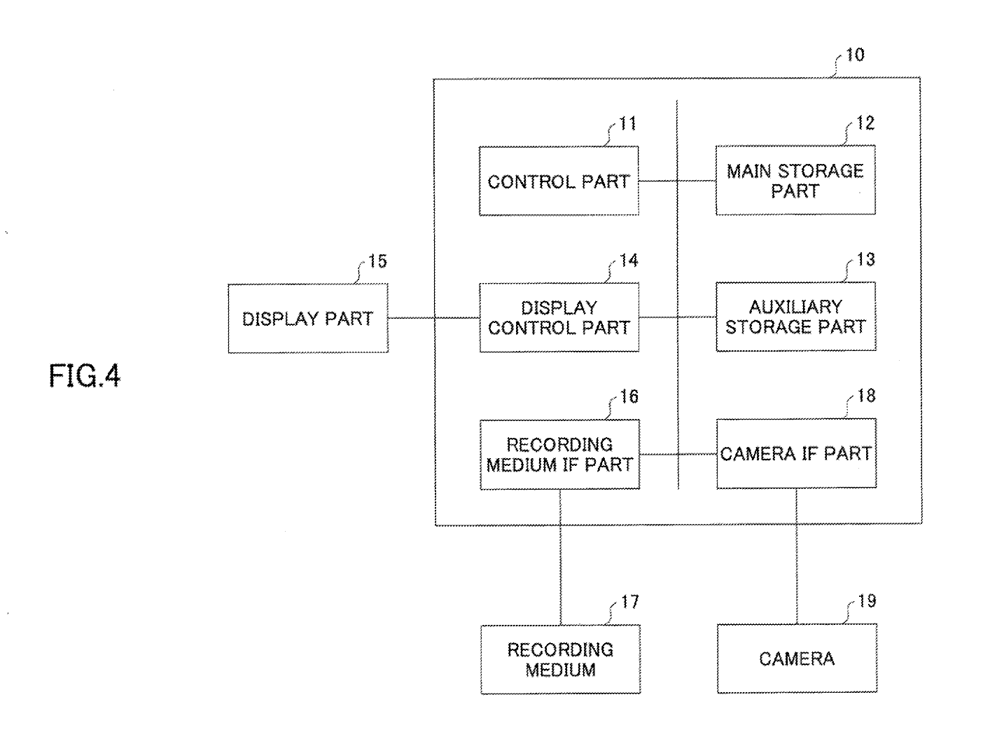

FIG. 4 is a diagram illustrating an example of a configuration of an image processing device 10. The image processing device 10 illustrated in FIG. 4 serves as the tampering prevention device 1 configured to prevent tampering with an image. The image processing device 10 illustrated in FIG. 4 includes a control part 11, a main storage part 12, an auxiliary storage part 13, a display control part 14, a recording medium interface (IF) part 16, and a camera interface (IF) part 18. The aforementioned parts are mutually connected via a bus such that data is mutually transmitted and received between these parts.

The control part 11 serves as a central processing unit (CPU) configured to control the respective devices, and carry out arithmetic operations and processing on data within a computer. Further, the control part 11 serves as a processor configured to execute programs stored in the main storage part 12, or programs stored in the auxiliary storage part 13. The control part 11 is also configured to receive data from the main and auxiliary storage parts 12 and 13, respectively, carry out arithmetic operations or processing on the received data, and output the processed data to the main and auxiliary storage parts 12 and 13 or an output part.

For example, the control part 11 serves as the tampering prevention function to prevent tampering with an image by executing a tampering prevention program stored in the auxiliary storage part 13.

The main storage part 12 may be a random access memory (RAM), which permanently or temporarily stores computer programs or data including basic software of an operating system (OS), or application software executed by the control part 12. Further, the main storage part 12 serves as a working memory in which the programs or data are loaded.

The auxiliary storage part 13 may be a storage device such as a hard disk drive (HDD), which stores data associated with the application software, or the like. The auxiliary storage part 13 is configured to store the tampering prevention program.

The auxiliary storage part 13 is further configured to store an image acquired from the camera IF part 18. Further, the auxiliary storage part 13 may also store an image acquired from a recording medium 17, and the like.

The display control part 14 is configured to perform display control in order to display images or data on a display part 15.

The recording medium interface (IF) part 16 serves as an interface between the image processing device 10 and the recording medium 17 (e.g., a flash memory) connected to the image processing device 10 via a data transmission channel such as a universal serial bus (USB).

Further, the recording medium 17 may also store a predetermined program (e.g., a tampering prevention program), which is installed in the image processing device 10 via the recording medium IF part 16. Thus, the installed predetermined program may be readily executable by the image processing device 10.

Note that if the recording medium 17 is a secure digital (SD) card, the recording medium IF part 16 may be an SD card slot.

The camera IF part 18 is configured to acquire an image taken by a camera 19. The acquired image is stored in the main storage part 12. Note that the camera 19 or the display part 15 may be incorporated into the image processing device 10.

Further, the image processing device 10 further includes a communication part configured to perform wired or wireless communications. The communication part may send a compressed image, a public key, and a digital signature to the tampering detection device 2.

Tampering Prevention Function

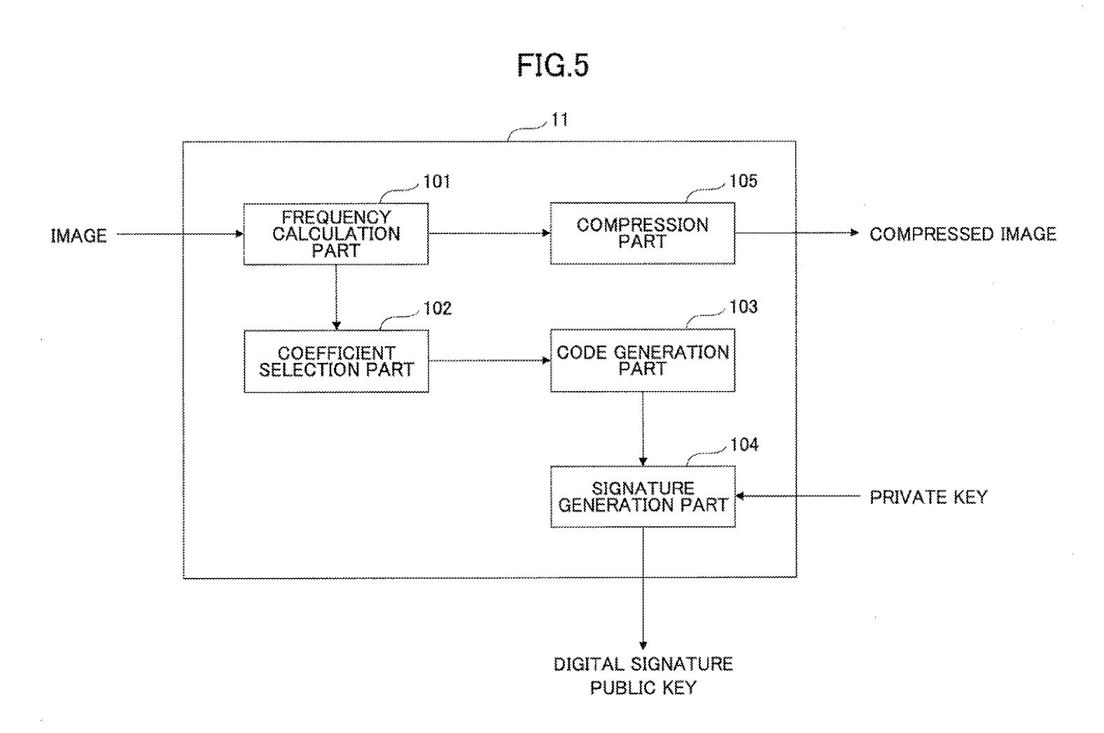

Next, the control part 11 having a tampering prevention function is described in more detail. FIG. 5 is a block diagram illustrating an example of a tampering prevention function in the first embodiment. The control part 11 illustrated in FIG. 5 includes a frequency calculation part 101, a coefficient selection part 102, a code generation part 103, a signature generation part 104, and a compression part 105. Note that an image desired to be protected from tampering, and a unique private key are input data that is input to the image processing device 10.

The frequency calculation part 101 is configured to calculate frequency coefficients of an image. The frequency calculation part 101 may divide an image into 8×8 blocks, and calculate frequency coefficients corresponding to each of the blocks utilizing frequency conversion, in a manner similar to Joint Photographic Experts Group (JPEG). The frequency calculation part 101 is configured to output the calculated frequency coefficients to a coefficient selection part 102.

The coefficient selection part 102 is configured to combine any two of the frequency coefficients as a pair, and select plural pairs of the frequency coefficients. A method for selecting two of the frequency coefficients includes, for example, selecting one of the frequency coefficients in a raster-scanning order, and selecting the other one of the frequency coefficients according to a predetermined standard. The coefficient selection part 102 outputs the selected pairs of the frequency coefficients to the code generation part 103.

The code generation part 103 is configured to generate a code based on a comparison result between an absolute value of the difference between the two frequency coefficients of each of the selected pairs and a threshold, and a magnitude relationship between the two frequency coefficients. The generated code is stored in the signature generation part 104.

The signature generation part 104 is configured to encrypt the acquired code with a private key, and output the encrypted code as a digital signature. The signature generation part 104 may acquire the private key from the main storage part 102, or the like.

The compression part 105 is configured to compress an image to reduce the size of the image. The compression part 105 is configured to output the compressed image. Note that the compression part 105 may optionally be arranged in the control part 11 of the image processing device 10, and may be arranged in other devices.

The image processing device 10 is configured to output the compressed image, the generated digital signature, and a public key corresponding to the unique private key. The aforementioned information may be used in the later-described tampering detection. Next, processing performed by the tampering prevention device 1 is described in more detail.

Frequency Calculation Part

The frequency calculation part 101 is configured to divide an image into predetermined blocks (e.g., 8×8 pixel blocks). The frequency conversion utilized by the frequency calculation part 101 may be discrete cosine transform (DCT), or wavelet transformation.

Coefficient Selection Part

The coefficient selection part 102 is configured to select plural pairs of the combined two frequency coefficients from the frequency coefficients calculated per block. The combined two frequency coefficients may, for example, be selected by the following two methods.

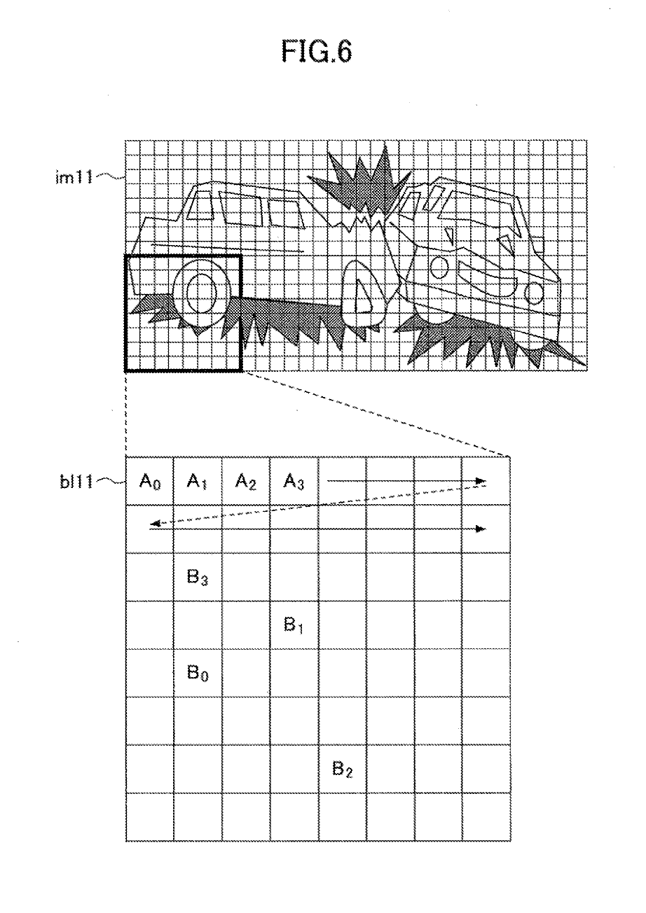

FIG. 6 is a diagram illustrating one of the methods for selecting the combination of the two frequency coefficients. The example illustrated in FIG. 6 indicates a method for selecting the combination of the frequency coefficients from an 8×8 block bl 11 taken from a car crash image im 11.

In this method, the coefficient selection part 102 selects frequency coefficients A₀, A₁, . . . in a predetermined scanning (e.g., raster-scanning) order, and randomly selects frequency coefficients Bₙ corresponding to the selected frequency coefficients Aₙ to form a pair of the frequency coefficients Aₙ and Bₙ. The location of the randomly selected Bₙ may be shared with the tampering detection device 2.

The coefficient selection part 102 determines the plural pairs of the frequency coefficients (A₀, B₀), (A₁, B₁), . . . in this manner. The plural pairs of the frequency coefficients may be selected from one block (within one block), or may be selected from two or more blocks (bridging two or more blocks).

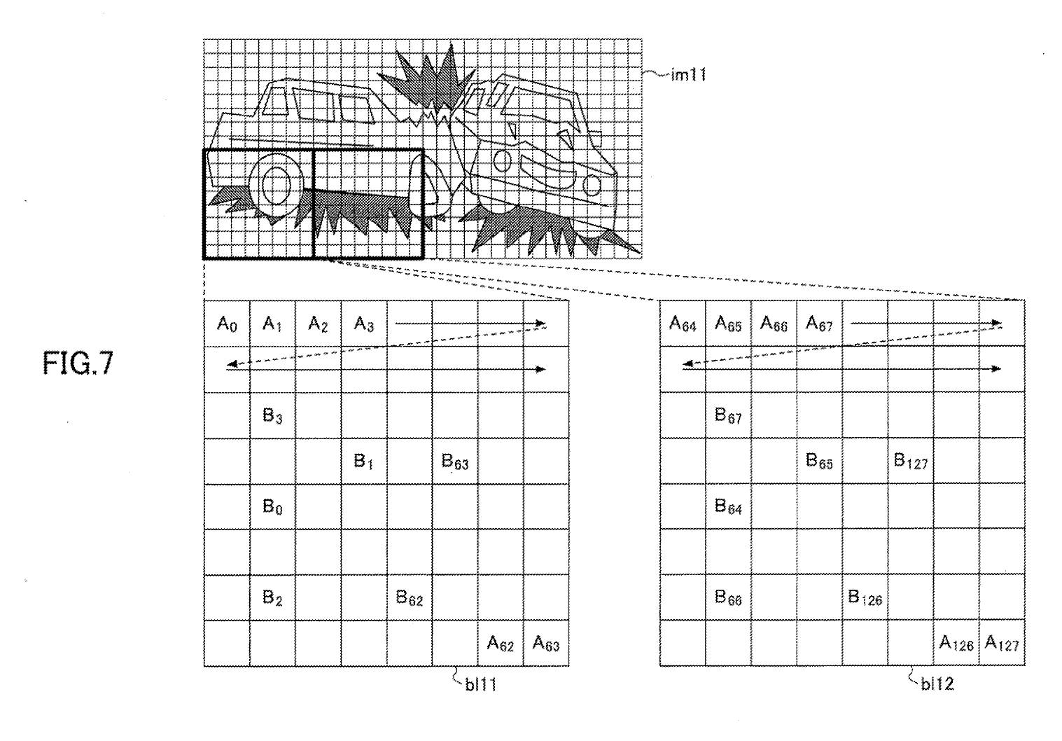

FIG. 7 is a diagram illustrating another method for selecting the combination of the two frequency coefficients. The example illustrated in FIG. 7 indicates a method for selecting plural pairs of the frequency coefficients from a range bridging two blocks of the car crash image Im 11. As illustrated in FIG. 7, the coefficient selection part 102 selects one of the frequency coefficients Aₙ in the raster-scanning order from each of the blocks bl 11 and bl 12, and randomly selects the other frequency coefficient Bₙ corresponding to the selected frequency coefficient Aₙ from a range bridging the blocks bl 11 and bl 12.

In this method, since the pair of the frequency coefficients (Aₙ, Bₙ) selected by the coefficient selection part 102 is selected from the range of the blocks bl 11 and bl 12, it may become difficult for a third party to anticipate the pair.

Note that the coefficient selection part 102 may select the pair in order to minimize the number of null codes generated in the later-described code generation part 103. More specifically, the coefficient selection part 102 may select the pair by selecting the frequency coefficient A in the scanning order from A₀ . . . , which may provide a maximum absolute difference in combination with the frequency coefficient B. Note that a frequency coefficient Bᵢ forming a pair with a frequency coefficient Aᵢ may be overlapped (i.e., repeatedly used). At this moment, information on the selected frequency coefficient Bᵢ may be output to the tampering detection device 2.

Code Generation Part

The code generation part 103 is configured to generate a code by calculating the following equations (1) and (2) based on the pair of the frequency coefficients selected by the coefficient selection part 102. The generated code is represented by D.

$$\begin{matrix}\{ \begin{matrix}{D}_{i} = 00 & ( ‖ {A}_{i} - {B}_{i} ‖ \geq α AND {A}_{i} \geq {B}_{i} ) \\ {D}_{i} = 11 & ( ‖ {A}_{i} - {B}_{i} ‖ \geq α AND {A}_{i} < {B}_{i} ) \\ {D}_{i} = 01 ( null ) & ( otherwise )\end{matrix} \\ α represents threshold ( α \geq 0 ) & ( 1 ) \\ D = \{ {D}_{0} {D}_{1} {D}_{2} , … \} & ( 2 )\end{matrix}$$

Properties of Code D

According to the equations (1) and (2), the code D is generated based on a comparison result between an absolute value of the difference between the two frequency coefficients and a threshold α, and a magnitude relationship between the two frequency coefficients. If the absolute value of the difference between the two frequency coefficients of the selected pair is greater than or equal to a threshold α, a value of binary data “00” or “11” is assigned to the pair based on the magnitude relationship between the two frequency coefficients. If the absolute value of the difference between the two frequency coefficients of the selected pair is less than the threshold α, a value indicating a null code “01” is assigned to the pair.

The reason for assigning the null code is as follows. If the absolute value of the difference between the two frequency coefficients of the pair is small, the absolute value of the difference between the two frequency coefficients of the pair may be “0” after the compression of the image. Accordingly, if the absolute value of the difference is less than the threshold, the null code is assigned in order not to employ the absolute value for the comparison.

Reason why Cord D is not Affected by Recompression

When an image is compressed, a magnitude relationship between the two frequency coefficients of the pair before the compression or after the first compression is as follows. If the difference between the two frequency coefficients is sufficiently large, the magnitude relationship between the two frequency coefficients will not be changed due to the image compression.

That is, when the code generation part 103 generates a code, the code generation part 103 assigns a code “00” or “01” to the pair of the frequency coefficients. Further, when the absolute value of the difference between the two frequency coefficients of the pair is less than the threshold α, the null code “01” is assigned to the pair.

Accordingly, the code generation part 103 may be able to generate a code D that is not affected by the image compression. Since the code D is not affected by the image compression, the digital signature generated from the code D will not be affected by the image compression. Note that the image compression includes recompression of the image.

Signature Generation Part

The signature generation part 104 is configured to encrypt the code D generated by the code generation part 103 with a private key unique to the image processing device 10 (i.e., the tampering prevention device 1) to output the encrypted code D. The signature generation part 104 may calculate a hash value utilizing an existing hash function such as SHA-1, and finally encrypts the hash value utilizing the private key to output the encrypted hash value as signature data.

### Specific Examples

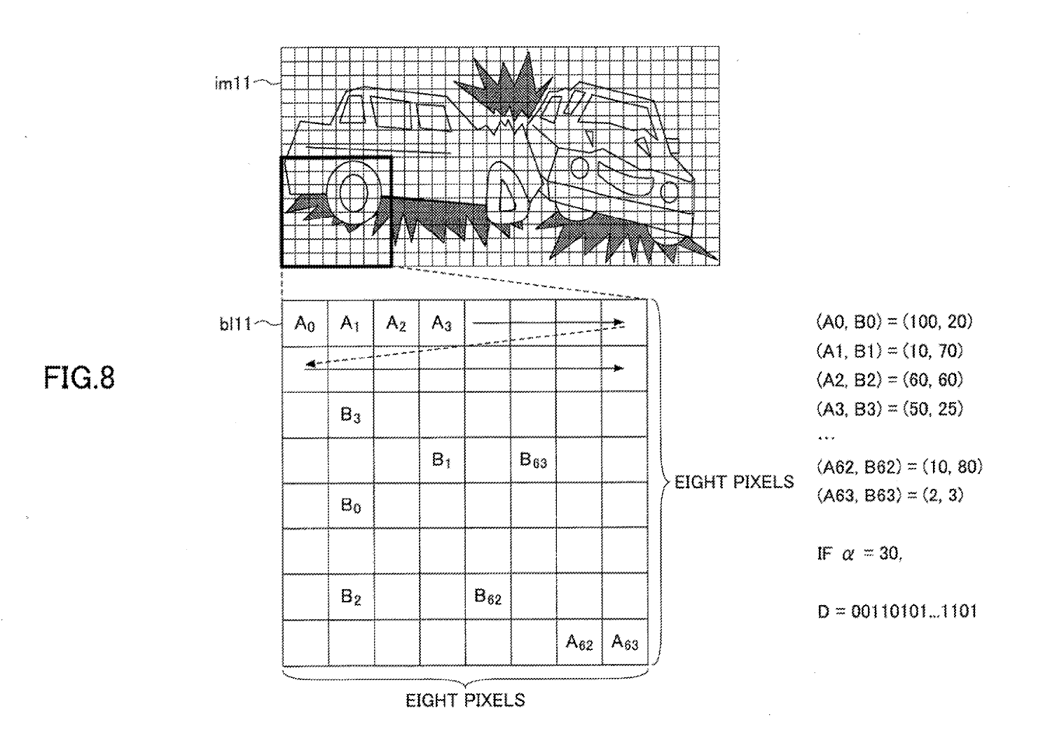

Next, tampering prevention processing in the first embodiment is described with reference to the following specific examples. FIG. 8 is a diagram illustrating a specific example of generating the code D. In the example illustrated in FIG. 8, the coefficient selection part 102 selects pairs (Aᵢ, Bᵢ) (i=0 to 63) corresponding to the frequency coefficients within a block bl 11 taken, for example, from an image im 11. In the example illustrated in FIG. 8, the frequency coefficients Aᵢ are selected in a raster-scanning order, and the frequency coefficients Bᵢ are randomly selected.

The following pairs may be selected by the coefficient selection part 102.

$$( {A}_{0} , {B}_{0} ) = ( 100 , 20 )$$

$$( {A}_{1} , {B}_{1} ) = ( 10 , 70 )$$

$$( {A}_{2} , {B}_{2} ) = ( 60 , 60 )$$

$$( {A}_{3} , {B}_{3} ) = ( 50 , 25 )$$

$$… \\ ( {A}_{62} , {B}_{62} ) = ( 10 , 80 )$$

$$( {A}_{63} , {B}_{63} ) = ( 2 , 3 )$$

If the threshold α is 30, the code generation part 103 assigns the following binary data to each of the pairs based on the equation (1).

$${D}_{0} = 00$$

$${D}_{1} = 11$$

$${D}_{2} = 01$$

$${D}_{3} = 01$$

$$…$$

$${D}_{62} = 11$$

$${D}_{63} = 01$$

The code generation part 103 generates a code D by sequentially aligning Dᵢ.

### D=00110101 . . . 1101

Accordingly, the code generation part 103 may be able to generate a code D that is not affected by the image compression.

Operation

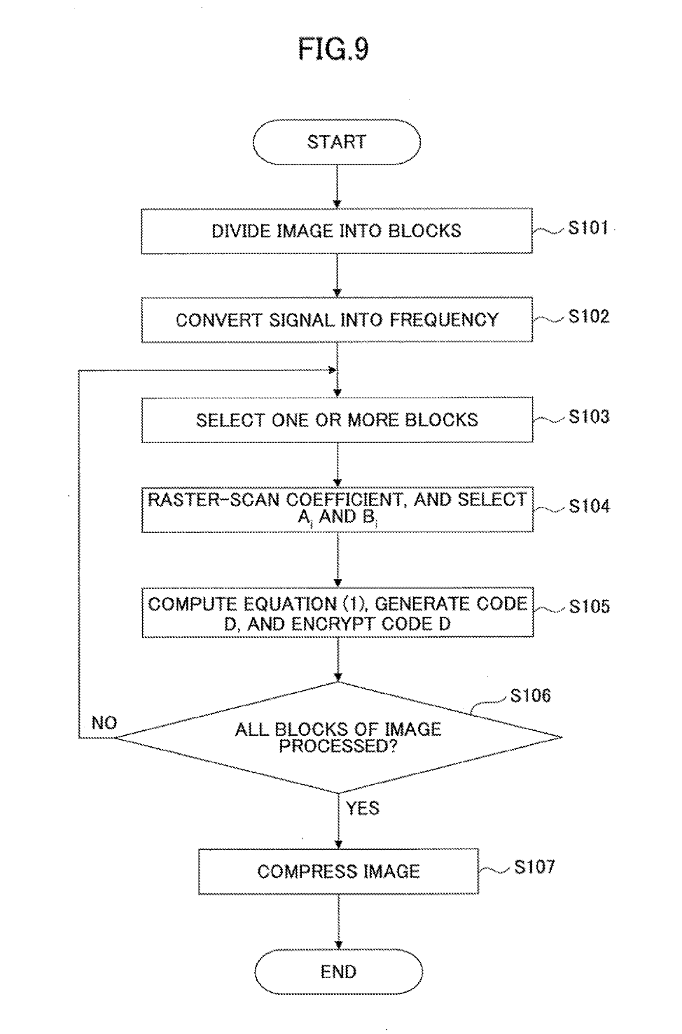

Next, an operation of the image processing device 10 serving as the tampering prevention device 1 in the first embodiment is described. FIG. 9 is a flowchart illustrating an example of tampering prevention processing in the first embodiment.

In step S101 illustrated in FIG. 9, upon reception of an image subjected to tampering prevention, the frequency calculation part 101 divides the received image into 8×8 pixel blocks.

In step S102, the frequency calculation part 101 performs frequency conversion on each of the blocks. The frequency conversion may be discrete cosine transform (DCT), or wavelet transformation.

In step S103, the coefficient selection part 102 selects one block or plural blocks.

In step S104, the coefficient selection part 102 raster-scans frequency coefficients within the selected block(s) to determine the raster-scanned frequency coefficients as A₀, A₁, A₂, . . . , and A₆₃. Further, the coefficient selection part 102 selects counterpart frequency coefficients Bᵢ paired with a corresponding one of the frequency coefficients Aᵢ.

In step S105, the code generation part 103 generates a code D based on the equation (1). Then, the signature generation part 104 encrypts the generated code D with the private key. Alternatively, the signature generation part 104 may calculate a hash value utilizing a hash function.

In step S106, the control part 11 determines whether all the blocks within the image have been processed. If all the blocks in the image have been processed (“YES” in step S106), step S107 is performed. If all the blocks in the image have not been processed (“NO” in step S106), step S103 is performed (back to step S103).

In step S107, the compression part 105 compresses an image subjected to tampering prevention.

As described above, according to the first embodiment, the tampering prevention processing that provides mathematical grounds indicating the image being not tampered with out detecting the compressed image as tampering may be carried out. That is, since the disclosed technology utilizes a framework of a digital certificate that verifies mathematical robustness, the disclosed technology exhibits resistance to hacking in a manner similar to the digital signature.

Further, the disclosed technology utilizes properties of the magnitude relationship between the two frequency coefficients before and after the image compression. That is, even if the image is compressed, the value of the signature data will not be changed. Therefore, the compressed image will not be detected as tampering. Accordingly, the disclosed technology does not detect the compression as tampering, and exhibits high resistance to hacking.

### Second Embodiment

Next, an image processing device 10 according to a second embodiment is described. The image processing device 10 according to the second embodiment serves as the tampering prevention device 1. In the second embodiment, in order to reduce the null data for the code D, noise is added to, or subtracted from the frequency coefficients.

Configuration

A configuration of the image processing device 10 according to the second embodiment is similar to that of the image processing device 10 according to the first embodiment. Therefore, the repeated description is omitted. Note that in the illustration of the configuration of the image processing device 10 according to the second embodiment, the same reference numerals illustrated in FIG. 4 are used.

Tampering Prevention Function

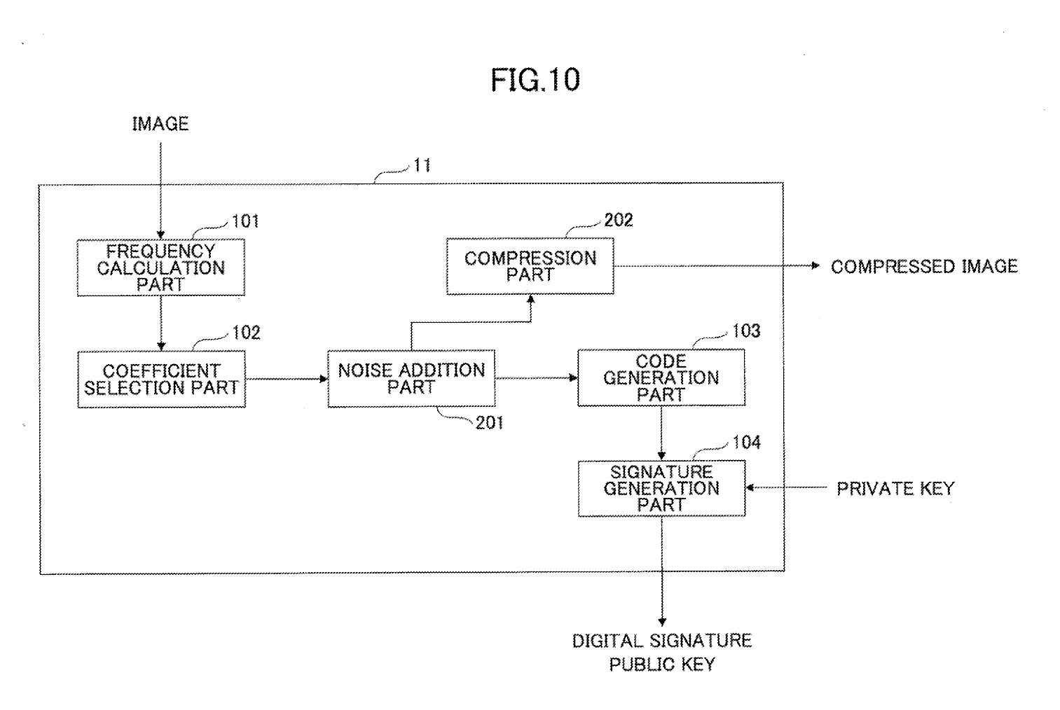

Next, the control part 11 having a tampering prevention function is described in more detail. FIG. 10 is a block diagram illustrating an example of a tampering prevention function in the second embodiment. In the functions illustrated in FIG. 10, the functions similar to those illustrated in FIG. 5 are provided with the same reference numerals, and the repeated descriptions are omitted.

A noise addition part 201 is configured to add noise to, or subtract noise from the pair of the two frequency coefficients, such that the absolute value of the difference between the two frequency coefficients exceeds a threshold in a case where the absolute value of the difference between the two frequency coefficients of the pair selected by the coefficient selection part 102 is less than the threshold, but falls within a predetermined range of the threshold. The noise is determined as a value that will not affect the image quality. The noise addition part 201 is configured to output to a compression part 202 the image having a block containing the frequency coefficients to which noise is added.

The noise addition part 201 is configured to output to a code generation part 103 plural pairs of the frequency coefficients including the pair of the frequency coefficients to which noise is added. Processing of the code generation part 103, and the signature generation part 104 are the same as those described in the first embodiment.

The compression part 202 is configured to perform compression processing on the image having the block containing the frequency coefficients to which noise is added. The compressed image may be output to the tampering detection device 2, and the like. Next, the noise addition part 201 is described in more detail.

Noise Addition Part

The noise addition part 201 is configured to add noise to, or subtract noise from one of the two frequency coefficients of the pair to increase the difference between the two frequency coefficients of the pair in a case where the difference between the two frequency coefficients of the pair selected by the coefficient selection part 102 falls within a predetermined range.

$$If β \leq ‖ {A}_{i} - {B}_{i} ‖ < α , \\ \{ \begin{matrix}{A}_{i} ← {B}_{i} + α & ( {A}_{i} \geq {B}_{i} ) \\ {B}_{i} ← {A}_{i} + α & ( {B}_{i} > {A}_{i} )\end{matrix} \\ Or \\ \{ \begin{matrix}{B}_{i} ← {A}_{i} - α & ( {A}_{i} \geq {B}_{i} ) \\ {A}_{i} ← {B}_{i} - α & ( {B}_{i} > {A}_{i} )\end{matrix} \\ where ( α \geq 0 , β \geq 0 ) \qquad ( 3 )$$

The equation (3) may prevent the tampering detection capability from lowering due to null codes numerously generated based on the equations (1) and (2). For example, if all the generated codes are null codes, the codes before tampering, and the codes calculated from the image of which the compression ratio is increased after tampering become all null codes. Accordingly, it may be difficult to detect the tampering.

Hence, the tampering prevention device 1 according to the second embodiment includes the noise addition part 201 configured to perform an operation represented by the equation (3) so as to reduce the number of null codes while improving the tampering detection capability. For example, consider a case where the absolute value of the difference |Aᵢ−Bᵢ| is 9, and the threshold α is 10. In this case, if the absolute value of the difference is +1, it may be unnecessary to utilize a null code.

Hence, if the absolute value of the difference is close to the threshold, the absolute value of the difference between Aᵢ and Bᵢ is set by adding noise to, or subtract noise from the frequency coefficients such that the absolute value of the difference exceeds the threshold to the extent that the original image will not deteriorate.

For example, consider a case where the absolute value of the difference |Aᵢ−Bᵢ| is 9, and the threshold β=9 and the threshold α=10. In this case, if the equation (3) is applied, the absolute value of the difference is α. Therefore, it may be unnecessary to utilize a null code.

Further, as another example, if Aᵢ=12, Bᵢ=3, α=10, and β=9, 8≦|12−3|<10. Hence, Aᵢ=13 (Bᵢ=3), or Bᵢ=2 (Aᵢ=12) is obtained. As described above, the noise addition part 201 adjusts the frequency coefficients by utilizing noise.

Further, the thresholds α and β may be selected according to the compression ratio of the image. If the expected compression ratio is high, the threshold α is increased, and the threshold β is decreased. By contrast, if the expected compression ratio is low, the threshold α is decreased, and the threshold β is increased. As a result, erroneous detection may be reduced.

Note that the threshold β is a parameter that affects image quality, and hence, the threshold β may be adjusted according to the required image quality. If the threshold β is small, noise to be added or to be subtracted may be increased. Accordingly, the image quality may deteriorate. There is a trade-off relationship between the image quality and the erroneous detection ratio. Therefore, it may be preferable to set an empirically optimal value for the threshold β. The compression ratio may be tabulated in advance with parameters assigned as α or β, and the noise addition part 201 may dynamically select the parameters from the table to be assigned to the threshold α or β.

### Specific Examples

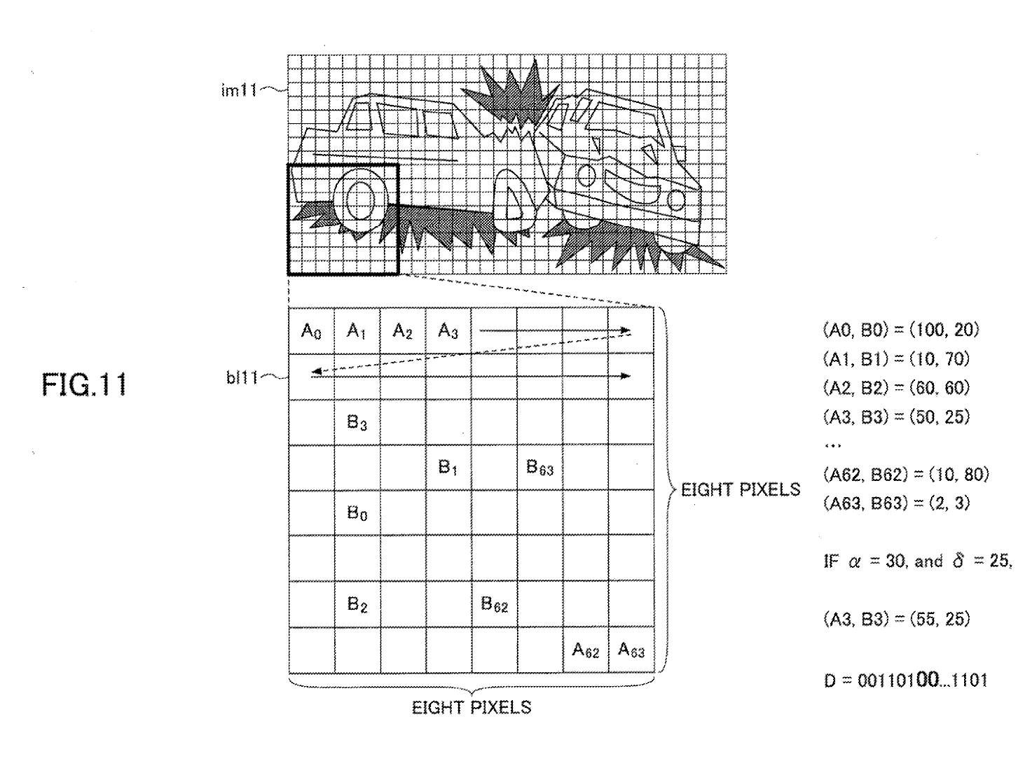

Next, tampering prevention processing in the second embodiment is described with reference to the following specific examples. FIG. 11 is a diagram illustrating another specific example of generating a code D. In the example illustrated in FIG. 11, the coefficient selection part 102 selects pairs (Aᵢ, Bᵢ) (i=0 to 63) corresponding to the frequency coefficients within a block bl 11 taken, for example, from an image im 11. In the example illustrated in FIG. 11, the frequency coefficients Aᵢ are selected by a raster-scanning order, and the frequency coefficients Bᵢ are randomly selected.

The following pairs may be selected by the coefficient selection part 102.

$$( {A}_{0} , {B}_{0} ) = ( 100 , 20 )$$

$$( {A}_{1} , {B}_{1} ) = ( 10 , 70 )$$

$$( {A}_{2} , {B}_{2} ) = ( 60 , 60 )$$

$$( {A}_{3} , {B}_{3} ) = ( 50 , 25 )$$

$$… \\ ( {A}_{62} , {B}_{62} ) = ( 10 , 80 )$$

$$( {A}_{63} , {B}_{63} ) = ( 2 , 3 )$$

If α=30, and β=25, only the pair (A₃, B₃)=(50, 25) is in compliance with a condition expressed by the equation (3). Accordingly, the pair may be changed by utilizing the equation (3), which may result in the pair (A₃, B₃)=(55, 25).

Next, the code generation part 103 assigns the following binary data to each of the pairs based on the equation (1).

$${D}_{0} = 00$$

$${D}_{1} = 11$$

$${D}_{2} = 01$$

$${D}_{3} = 00$$

$$…$$

$${D}_{62} = 11$$

$${D}_{63} = 01$$

The code generation part 103 generates a code D by sequentially aligning Dᵢ.

### D=00110100 . . . 1101

Accordingly, the code generation part 103 may be able to generate the code D that is not affected by the image compression.

Operation

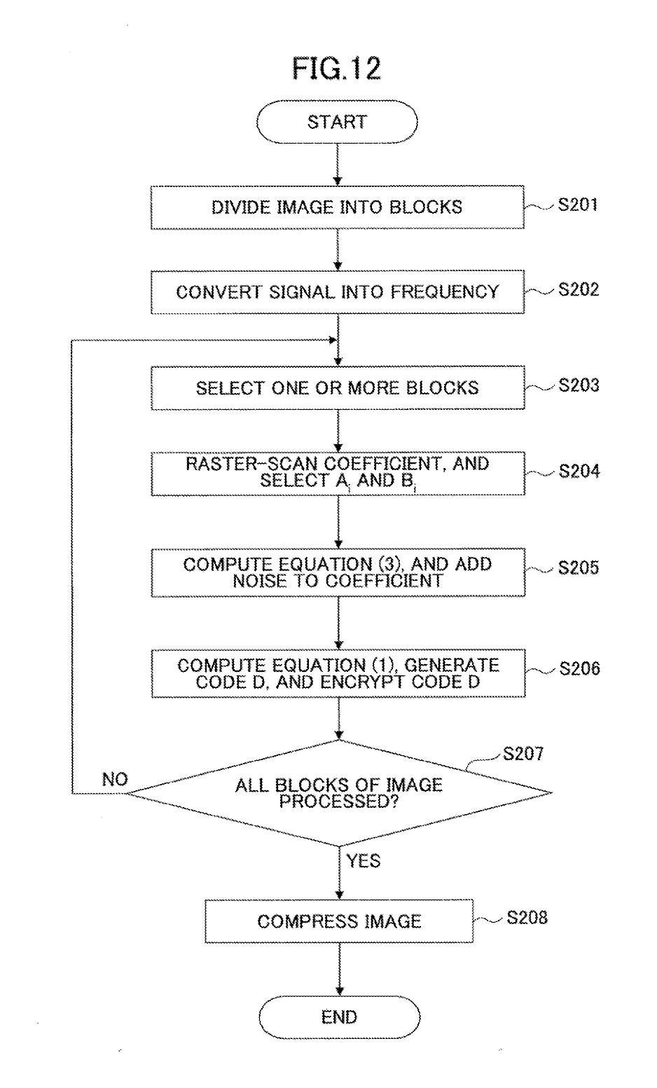

Next, an operation of the tampering prevention device 1 according to the second embodiment is described. FIG. 12 is a flowchart illustrating an example of tampering prevention processing in the second embodiment. Note that possessing in steps S201 to S204, and steps S206 to S208 illustrated in FIG. 12 are similar to those in steps S101 to S104, and steps S105 to S107 illustrated in FIG. 9. Therefore, the repeated descriptions of the processing in FIG. 12 are omitted.

In step S205, the noise addition part 201 adds noise to pairs of the frequency coefficients that satisfy the condition by utilizing the equation (3). As a result, the number of null codes may be reduced while improving tampering detection capacity.

As described above, according to the second embodiment, the tampering detection capability corresponding to the tampering prevention processing that provides mathematical grounds indicating the image being not tampered with out detecting the compressed image as tampering may be further improved. Further, if the threshold β is small, the noise to be added is also small, which may be able to suppress the effect on the image quality.

### Third Embodiment

Next, an image processing device 30 according to a third embodiment is described. The image processing device 30 according to the third embodiment serves as a tampering detection device 2. The image processing device 30 commonly performs tampering detection processing on the images output from the tampering prevention device 1 according to the first and the second embodiments.

Configuration

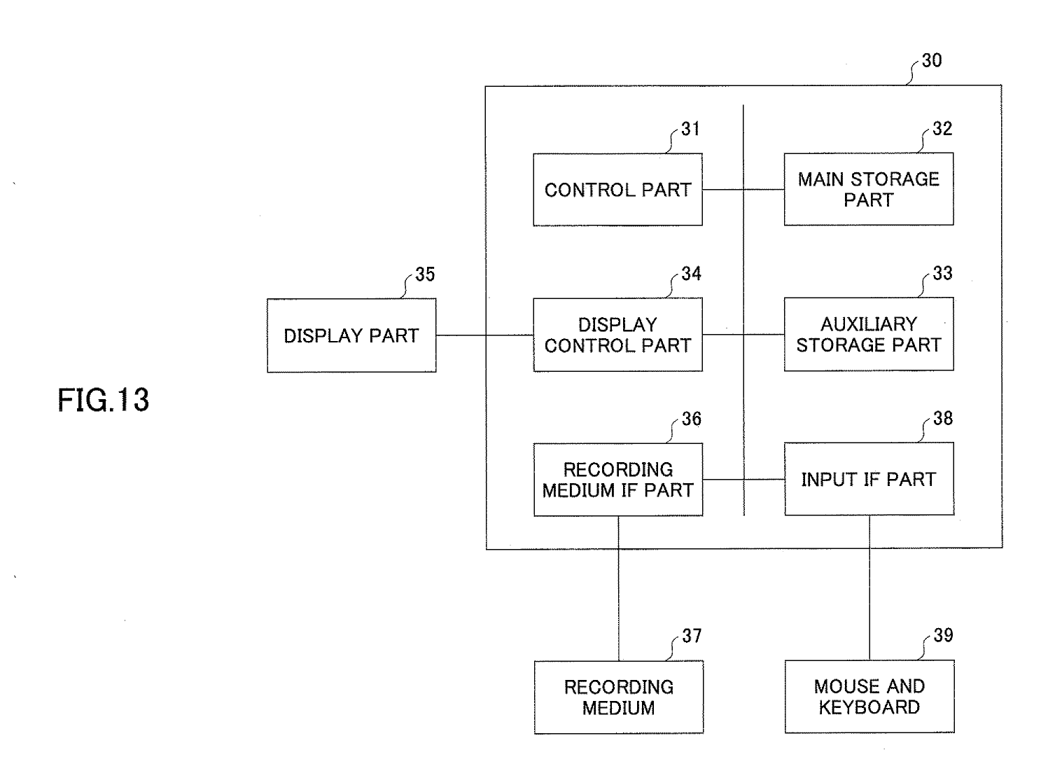

FIG. 13 is a diagram illustrating an example of a configuration of the image processing device 30. The image processing device 30 illustrated in FIG. 13 serves as the tampering detection device 2 configured to detect tampering with an image. The image processing device 30 illustrated in FIG. 13 includes a control part 31, a main storage part 32, an auxiliary storage part 33, a display control part 34, a recording medium IF part 36, and an input IF part 38. The aforementioned parts are mutually connected via a bus such that data is mutually transmitted and received between these parts.

The control part 31 serves as a central processing unit (CPU) configured to control the respective devices, and carry out arithmetic operations and processing on data within a computer. Further, the control part 31 serves as a processor configured to execute programs stored in the main storage device 32, or in the auxiliary storage device 33. The control part 31 is also configured to receive data from the main and auxiliary storage parts 32 and 33, carry out arithmetic operations or processing on the received data, and output the processed data to the main and auxiliary storage parts 32 and 33 or an output part.

For example, the control part 31 serves as a tampering detection function to detect tampering with an image by executing a tampering detection program stored in the auxiliary storage part 33.

The main storage part 32 may be a random access memory (RAM), which permanently or temporarily stores computer programs or data including basic software of an operating system (OS), or application software executed by the control part 32. Further, the main storage part 32 serves as a working memory in which the programs or data are loaded.

The auxiliary storage part 33 may be a storage device such as a hard disk drive (HDD), which stores data associated with the application software or the like. The auxiliary storage part 33 is configured to store the tampering detection program.

The auxiliary storage part 33 is further configured to store a compressed image acquired from the tampering prevention device 1, a public key, and a digital signature. Further, the auxiliary storage part 33 may also store an image acquired from a recording medium 37, and the like.

The display control part 34 is configured to perform display control in order to display images or data on a display part 35.

The recording medium interface (IF) part 36 serves as an interface between the image processing device 30 and the recording medium 37 (e.g., a flash memory) connected to the image processing device 30 via a data transmission channel such as a universal serial bus (USB).

Further, the recording medium 37 may also store a predetermined program (e.g., a tampering detection program), which is installed in the image processing device 30 via the recording medium interface (IF) part 36. Thus, the installed predetermined program may be readily executable by the image processing device 30.

Note that if the recording medium 37 is a secure digital (SD) card, the recording medium IF part 36 may be an SD card slot.

The input IF part 38 is configured to acquire data input via an input device 39 such as a mouse and a keyboard. The acquired data is stored in the main storage part 32 or the auxiliary storage part 33. Note that the input device 39 or a display part 35 may be incorporated into the image processing device 30.

Further, the image processing device 30 further includes a communication part configured to perform wired or wireless communications. The communication part may receive a compressed image, a public key, and a digital signature from the tampering prevention device 1.

Tampering Detection Function

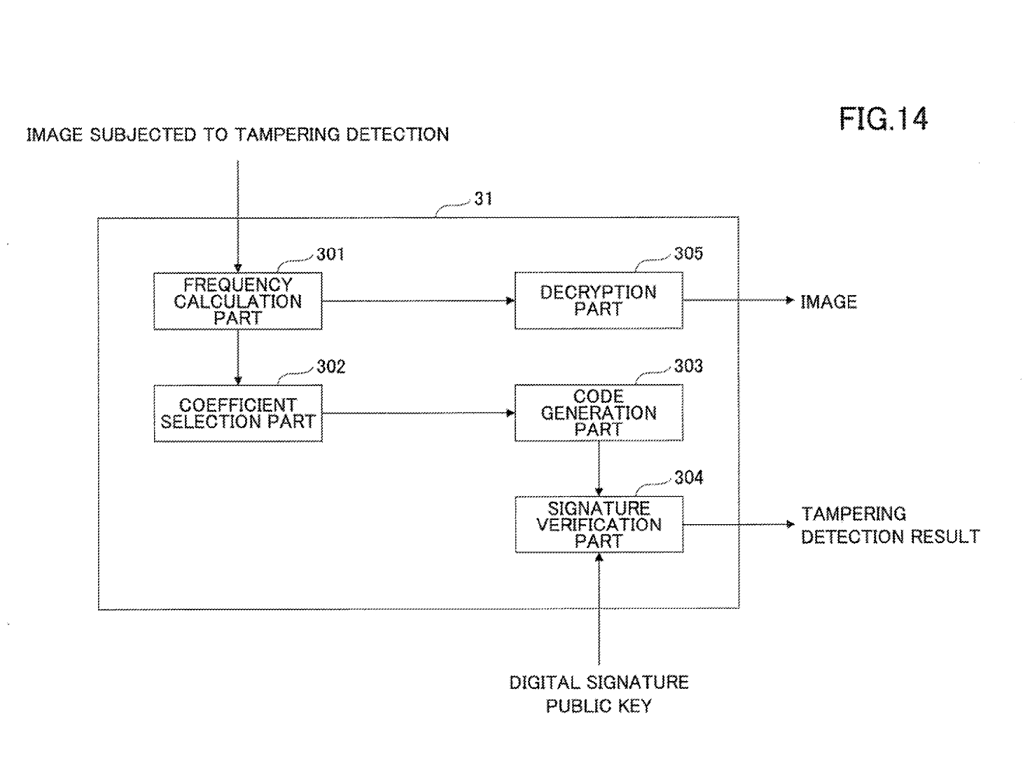

Next, the control part 31 having a tampering detection function is described in more detail. FIG. 14 is a block diagram illustrating an example of a tampering detection function in the third embodiment. The control part 31 illustrated in FIG. 14 includes a frequency calculation part 301, a coefficient selection part 302, a code generation part 303, a signature verification part 304, and a decryption part 305. Note that an image subjected to tampering detection, a digital signature, and a public key paired with the private key of the tampering prevention device 1 are input to the tampering detection device 2. The image subjected to tampering detection may be a compressed image.

The frequency calculation part 301 is configured to calculate frequency coefficients of an image. The frequency calculation part 301 may divide an image into 8×8 blocks, and calculate frequency coefficients corresponding to each of the blocks utilizing frequency conversion, in a manner similar to Joint Photographic Experts Group (JPEG). The frequency calculation part 301 is configured to output the calculated frequency coefficients to the coefficient selection part 302.

The coefficient selection part 302 is configured to combine any two of the frequency coefficients as a pair, and select plural pairs of the frequency coefficients. A method for selecting the two frequency coefficients may be similar to the selection method performed by the tampering prevention device 1. The coefficient selection part 302 outputs the selected pairs of the frequency coefficients to the code generation part 303.

The code generation part 303 is configured to generate a code based on a magnitude relationship between the two frequency coefficients of each of the selected pairs. The generated code is stored in the signature verification part 304.

The signature verification part 304 is configured to compare the code (also called a “decrypted code”) obtained by decrypting the digital signature with the public key acquired from the tampering prevention device 1, and the code (also called a “generated code”) generated by the code generation part 303 to verify the presence or the absence of tampering with an image subjected to tampering detection. When the signature verification part 304 compares the decrypted code and the generated code, the signature verification part 304 utilizes the decrypted codes excluding the null codes among the decrypted codes obtained by decrypting the digital signature for the comparison.

Further, the signature verification part 304 determines that there is no tampering with an image if the two codes match, whereas the signature verification part 304 determines that there is tampering with the image if the two codes do not match. The result of the presence or the absence of the tampering with the image may be displayed on the display part 35.

The decryption part 305 is configured to decrypt the image subjected to tampering detection. When the signature verification part 304 determines that there is tampering with the image, the tampering detection device 2 may display which part of the image is tampered with. Next, processing performed by the tampering detection device 2 is described in more detail. Processing of the frequency calculation part 301 and the coefficient selection part 302 are the same as those described in the first and the second embodiments. Therefore, the repeated descriptions are omitted.

Code Generation Part

The code generation part 303 assigns binary data to each of the pairs of the frequency coefficients based on the following equation (4).

$$\{ \begin{matrix}{D}_{i} = 00 & ( {A}_{i} \geq {B}_{i} ) \\ {D}_{i} = 11 & ( {A}_{i} < {B}_{i} )\end{matrix} \qquad ( 4 )$$

Signature Verification Part

First, the code generated by the tampering prevention device 1 is encrypted with a private key unique to the tampering prevention device 1 to form a digital signature. By contrast, the tampering detection device 2 generates a code (i.e., a generated code) from an image subjected to tampering detection.

Further, the signature verification part 304 decrypts the digital signature received from the tampering prevention device 1 with the public key to generate a code (i.e., a decrypted code). The signature verification part 304 compares the two codes (i.e., the generated code and the decrypted code). If the two codes match, the signature verification part 304 determines that there is no tampering with the image, whereas if the two codes do not match, the signature verification part 304 determines that there is tampering with the image.

Partial Tampering Detection

The tampering prevention device 1 may generate plural codes and plural digital signatures for each of the blocks of the image. In this case, the tampering detection device 2 verifies the plural signatures. If the tampering detection device 2 detects tampering, the tampering detection device 2 may transmit to the decryption part 305 information on a position at which tampering is detected, and depict a region in which the tampering is detected.

Note that since the frequency coefficients Aᵢ, each of which is one of the pairs, are aligned in the raster-scanning order, a pixel may be specified by a position of the code. Hence, when the two codes are compared, the tampering detection device 2 may be able to detect tampering at a pixel level by specifying data at which positions do not match.

### Specific Examples

Next, tampering detection processing in the third embodiment is described with reference to the following specific examples. In the illustration of the tampering detection processing in the third embodiment, a compressed image obtained by compressing the image illustrated in FIG. 11 is subjected to tampering detection.

Initially, the signature verification part 304 decrypts the digital signature generated by the tampering prevention device 1 to generate a code. In this example, it is assumed that the “code D=0010100 . . . 1101” generated by the tampering prevention device 1 according to the second embodiment is obtained.

The coefficient selection part 302 is configured to select plural pairs of the frequency coefficients in a manner similar to that in the tampering prevention device 1 according to the second embodiment. The selected pairs of the frequency coefficients are as follows.

$$( {A}_{0} , {B}_{0} ) = ( 96 , 20 )$$

$$( {A}_{1} , {B}_{1} ) = ( 10 , 67 )$$

$$( {A}_{2} , {B}_{2} ) = ( 60 , 56 )$$

$$( {A}_{3} , {B}_{3} ) = ( 52 , 25 )$$

$$… \\ ( {A}_{62} , {B}_{62} ) = ( 10 , 77 )$$

$$( {A}_{63} , {B}_{63} ) = ( 0 , 0 )$$

Note that the code generation part 303 assigns binary data to each of the pairs of the frequency coefficients based on the aforementioned equation (4).

$${{D}^{′}}_{0} = 00$$

$${{D}^{′}}_{1} = 11$$

$${{D}^{′}}_{2} = 00$$

$${{D}^{′}}_{3} = 00$$

$$…$$

$${{D}^{′}}_{62} = 11$$

$${{D}^{′}}_{63} = 01$$

The code generation part 303 generates a code D′ noted below by sequentially aligning the above D′ᵢ.

### D′=00110000, . . . , 1101

The signature verification part 304 decrypts the code generated by the tampering prevention device 1 according to the second embodiment with a public key. For example, the decrypted code may be as follows.

### D=00110100 . . . 1101

Among the codes D of the tampering prevention device 1, the signature verification part 304 excludes one of the two codes (i.e., the code D and the code D′) that is located at a position of the null code (01) from the codes subjected to code comparison. For example, it is assumed that the null code is replaced with “xx”. Further, among the codes D′, the signature verification part 304 replaces data with “xx”, the data bing located at the same position where the code D is replaced with the “xx”.

In this case, the two codes result in as follows.

D′=0011xx00, . . . , 11xx
D=0011xx00, . . . , 11xx
Hence, the two codes D and D′ match.
As a result, the signature verification part 304 determines that there is no tampering.

Operation

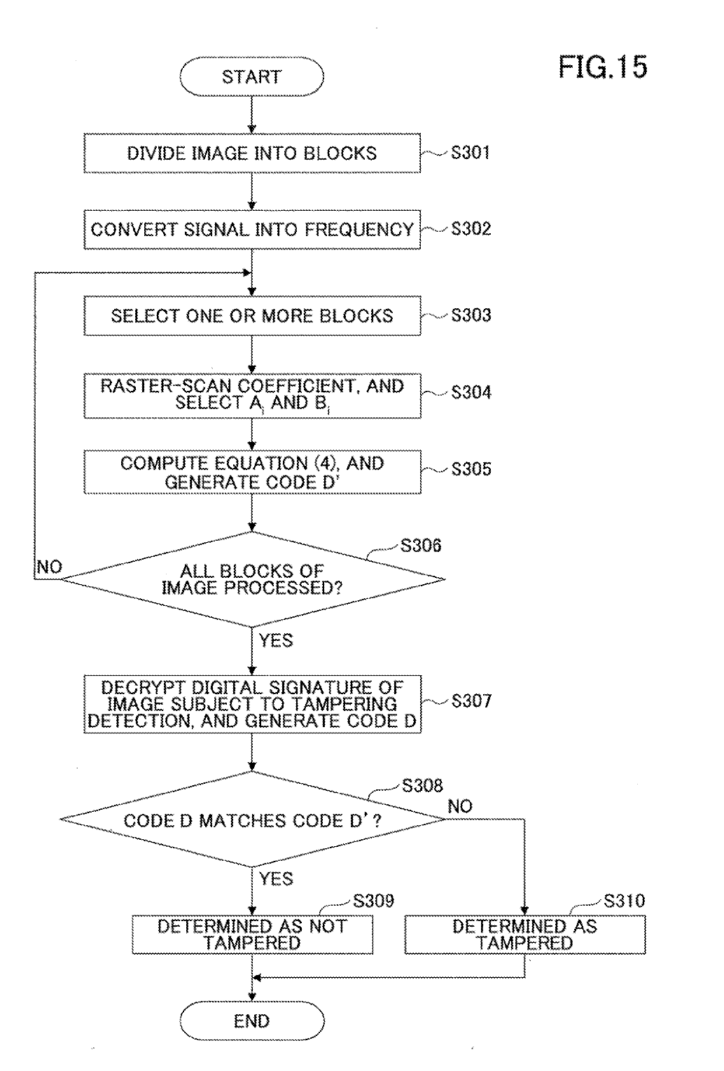

Next, an operation of the image processing device 30 serving as the tampering detection device 2 in the third embodiment is described. FIG. 15 is a flowchart illustrating an example of tampering detection processing in the third embodiment. According to the tampering detecting processing illustrated in FIG. 15, tampering is detected by inputting the digital signature generated in the first or the second embodiment, the compressed image, and the public key.

Since the processing in steps S301 to S304 illustrated in FIG. 15 is similar to that in steps S101 and S104 in FIG. 9, the repeated descriptions of the corresponding steps in FIG. 15 are omitted. Note that in the processing in FIG. 15, an image subjected to tampering detection is a compressed image.

In step S305, the code generation part 303 generates a code D′ based on the equation (4).

In step S306, the control part 31 determines whether all the blocks within the image have been processed. If all the blocks in the image have been processed (“YES” in step S306), step S307 is processed. If all the blocks in the image have not been processed (“NO” in step S306), step S303 is processed (back to step S303).

In step S307, the signature verification part 304 decrypts a digital signature of the image for which a user wishes to verify tampering, and generates a code D.

In step S308, the signature verification part 304 determines whether the code D matches the code D′. If the code D matches the code D′ (“YES” in step S308), step S309 is processed. If the code D does not match the code D′ (“NO” in step S308), step S310 is processed.

In step S309, the signature verification part 304 determines that the compressed image has not been tampered with.

In step S310, the signature verification part 304 determines that the compressed image has been tampered with.

As described above, according to the tampering detection processing in the third embodiment, it may be possible to determine that the simply compressed image has not been tampered with. Further, if there is tampering such as altering an image, a magnitude relationship between the two frequency coefficients will not be maintained. Therefore, it may be possible to detect the tampering with the image.

### MODIFICATION

Note that a non-transitory recording medium may store programs for implementing the tampering prevention processing and the tampering detection processing illustrated in the aforementioned embodiments. Accordingly, the tampering prevention processing and the tampering detection processing may be implemented by causing a computer to execute a tampering prevention program and a tampering detection program that are stored in the non-transitory recording medium. For example, the tampering prevention program and the tampering detection program may be recorded in a recording medium, and the recorded programs may be read by a computer or a mobile terminal apparatus to implement the tampering prevention processing and the tampering detection processing.

Note that various types of recording media may be used as the recording medium. Examples of the recording media include a recording medium such as a CD-ROM, a flexible disk and a magneto-optical disk on which information is optically, electrically or magnetically recorded; or a semiconductor memory such as a ROM or a flash memory in which information is electrically recorded.

The programs executed in the image processing device may have module configurations including the parts illustrated in the aforementioned embodiments. In the actual hardware, the control part retrieves the programs from the auxiliary storage part and executes the retrieved programs after loading one or more of the parts in the main storage part, so that the loaded parts may be accessed in the main storage part.

Further, the image subjected to the tampering prevention or the tampering detection may be moving images or video and the aforementioned processing may be carried out for each frame, or for each of the frames at a predetermined interval.

The disclosed technologies are described according to the embodiments and modification; however, the disclosed technologies are not limited to the disclosed embodiments and modification. Various modifications or alterations may be made within the scope of the inventions described in the claims. Further, combinations of all or part of the components of aforementioned embodiments and modification may be applied.

According to the disclosed technology, mathematical grounds indicating the image being not tampered with may be provided without detecting the compressed image as tampering.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the spirit and scope of the invention.

What is claimed is:

1. An image processing device comprising:
a frequency calculation part configured to calculate frequency coefficients of an image;
a coefficient selection part configured to select a plurality of pairs of the frequency coefficients from the calculated frequency coefficients;
a code generation part configured to generate a code based on a comparison result between an absolute value of a difference between the two frequency coefficients of each of the selected pairs and a threshold, and a magnitude relationship between the two frequency coefficients; and
a signature generation part configured to encrypt the generated code with a private key to generate a digital signature.

2. The image processing device as claimed in claim 1, wherein
when the absolute value of the difference between the two frequency coefficients of one of the pairs is less than the threshold, the code generation part assigns a null code to the one of the pairs having the absolute value of the difference less than the threshold.

3. The image processing device as claimed in claim 2, further comprising:
a noise addition part configured to add noise to, or subtract noise from any one of the two frequency coefficients when the absolute value of the difference between the two frequency coefficients of the one of the pairs is less than the threshold, and falls within a predetermined range of the threshold, such that absolute value of the difference between the two frequency coefficients of the one of the pairs exceeds the threshold.

4. The image processing device as claimed in claim 1, wherein
when selecting the pairs of the frequency coefficients, the coefficient selection part selects a first frequency coefficient in a predetermined scanning order, and selects a second frequency coefficient according to a predetermined standard.

5. The image processing device as claimed in claim 4, wherein
the predetermined standard specifies that the absolute value of the difference between the first frequency coefficient and the second frequency coefficient is maximum.

6. The image processing device as claimed in claim 1, wherein
the frequency calculation part calculates the frequency coefficients for each of blocks into which the image is divided, and
the coefficient selection part selects one of the pairs of the two frequency coefficients within one block, or bridging two or more blocks.

7. A tampering prevention method executed by a computer, the tampering prevention method comprising:
calculating, by a processor, frequency coefficients of an image;
selecting a plurality of pairs of the frequency coefficients from the calculated frequency coefficients;
generating a code based on a comparison result between an absolute value of a difference between the two frequency coefficients of each of the selected pairs and a threshold, and a magnitude relationship between the two frequency coefficients; and
encrypting the generated code with a private key to generate a digital signature.

8. An image processing device comprising:
a frequency calculation part configured to calculate frequency coefficients of an image subjected to tampering detection;
a coefficient selection part configured to select a plurality of pairs of the frequency coefficients from the calculated frequency coefficients;
a code generation part configured to generate a code based on a magnitude relationship between the two frequency coefficients of each of the selected pairs; and
a signature verification part configured to acquire a digital signature and a public key, and compare a code obtained by decrypting the digital signature with the public key and the code generated by the code generation part to verify presence or absence of tampering with the image subjected to tampering detection.

9. The image processing device as claimed in claim 8, wherein
the signature verification part makes the comparison of each of the decrypted codes excluding null codes and a corresponding one of the codes generated by the code generation part.

10. A tampering detection method executed by a computer, the tampering detection method comprising:
calculating, by a processor, frequency coefficients of an image subjected to tampering detection;
selecting a plurality of pairs of the frequency coefficients from the calculated frequency coefficients;
generating a code based on a magnitude relationship between the two frequency coefficients of each of the selected pairs; and
acquiring a digital signature and a public key, and comparing a code obtained by decrypting the digital signature with the public key and the generated code to verify presence or absence of tampering with the image subjected to tampering detection.
